(19) United States
(12) Patent Application Publication
(10) Pub. No.: US 2025/0002422 A1
(43) Pub. Date: Jan. 2, 2025

(54) METHOD OF PREPARING METAL HYDRATE FOR MINERAL FERTILIZER, HYDROPONIC CULTIVATION METHOD OF PLANT SPROUT USING THE SAME, AND VEGETABLE MATERIALS CULTIVATED BY THE METHOD

(71) Applicant: Inor Bio Co., Ltd., Hwaseong-si (KR)

(72) Inventors: Jong Soo CHO, Pyeongtaek-si (KR); Mi-Jin KANG, Pyeongtaek-si (KR); Dong Min LEE, Seongnam-si (KR); Eun JO, Seoul (KR); Pu Reum CHO, Seoul (KR)

(21) Appl. No.: 18/616,587

(22) Filed: Mar. 26, 2024

(30) Foreign Application Priority Data
Jun. 27, 2023 (KR) 10-2023-0082346

(51) Int. Cl. C05D 9/02; A01G 31/00; C01G 9/02; C01G 49/02

(52) U.S. Cl. CPC C05D 9/02; A01G 31/00; C01G 9/02; C01G 49/02

(57) ABSTRACT

According to the present disclosure, pure metal hydrate without chemicals is prepared and is used as a mineral fertilizer to germinate and grow seeds to improve the growth rate of plant sprouts and provide excellent human affinity and absorption rate and abundant amino acids, mineral nutrients, and antioxidants in grown plant sprouts so that it has the advantage of being able to be used as a vegetable raw material for cosmetics, health foods, hangover relievers, etc.

### CROSS-REFERENCE TO RELATED APPLICATION(S)

This application claims priority to Korean Patent Application No. 10-2023-0082346 filed in the Korean Intellectual Property Office on Jun. 27, 2023, the disclosure of which is incorporated by reference herein in its entirety.

### TECHNICAL FIELD

The present disclosure relates to a method of preparing metal hydrate for mineral fertilizer, hydroponic cultivation method of plant sprout using the same, and vegetable materials cultivated by the method, and more specifically, to a method of preparing metal hydrate for mineral fertilizer, hydroponic cultivation method of plant sprout using the same, and vegetable materials cultivated by the method in which pure metal hydrate without chemicals are prepared, and plant sprouts are grown hydroponically, thereby providing plant-based raw materials rich in antioxidants, vitamins, and human-friendly mineral nutrients.

### DISCUSSION OF RELATED ART

The three major nutrients for plant growth are nitrogen (N), phosphoric acid (PO₄⁻³), and potassium (K), and in addition, trace metal ions (copper, zinc, iron, manganese, magnesium) play an essential role in the plant metabolic process.

These trace metal ions play a major role in helping plants grow quickly just like the nutrients needed for human growth, increasing the yield of vegetables and fruits, and increasing the self-reliance of plants against pests and diseases, and lack of trace metal ions causes growth deficiency.

The trace metal ions have conventionally been provided to plants in the form of metal salts or sulfides (for example, zinc sulfate (ZnSO₄) or iron sulfate (FeSO₄)), but these sulfuric acid-reactive metal-based fertilizers are not suitable for hydroponic cultivation due to foliar fertilizer application. The reason is that the sulfate radical causes acid-dissolution, and the tender stage sprout plants become yellow and dissolve in the acid radical, limiting their growth.

In another form, these metals are made into very fine nanoparticles, and these nanoparticles are turned into a colloid that is stable in water or aqueous solutions, so that these metals are provided in the form of a colloid containing nanoparticles of a neutral metal. In this case, some neutral metals meet moisture in the plant's digestive system and become ionized.

However, since toxic substances formed during the manufacturing process of these nanoparticles are used, these toxic substances cause primary damage such as inhibition of plant growth, reduction of moisture transfer during photosynthesis, production of reactive oxygen species, and damage to DNA structure, and through these, a secondary problem such as the generation of by-products from plants, which are the main cause of environmental pollution.

### SUMMARY

An object of the present disclosure is to produce pure metal hydrate free of chemicals and provide the pure metal hydrate as a mineral fertilizer.

Another object of the present disclosure is to provide a hydroponic cultivation method of plant sprouts that can cultivate plant sprouts that have excellent growth and are rich in antioxidants, amino acids, and human-friendly mineral nutrients.

Another object of the present disclosure is to provide plant-based raw materials that are rich in antioxidants, amino acids and mineral nutrients, are human-friendly, and have excellent absorption by the human body.

Accordingly, the present disclosure provides a method of preparing a metal hydrate for mineral fertilizer, the method comprising contacting metal with ultra-high temperature plasma flame of 18,000 to 24,000° C. to grind the metal into extremely fine particles and reacting the extremely fine particles with water to produce the metal hydrate.

The size of the hydration ion in the metal hydrate is 0.5 nm to 50 nm, and the metal content in the metal hydrate is 1,200 ppm to 55,000 ppm.

The metal is zinc or iron, and the hydration ion in the metal hydrate is [Fe(H₂O)₂O₂]²⁺ or [Zn(H₂O)₆]²⁺.

The present disclosure provides a hydroponic cultivation method of plant sprouts, the method comprising a first step of producing the metal hydrate by the method of claim 1, a second step of adding plant seeds to the metal hydrate and soaking and swelling the plant seeds for 6 to 48 hours at a temperature of 15 to 35° C., a third step of placing the swollen seeds in an incubator and cultivating and rooting the swollen seeds for 8 to 48 hours while spraying the metal hydrate intermittently in shaded conditions, and a fourth step of growing for 0.5 to 72 hours while irradiating light to the rooted seeds and spraying the metal hydrate intermittently, thereby causing cotyledons to open and sprouts to grow photosynthetically.

The incubator is a reflex incubator in which a Reflex sheet with a luminance of 50 to 300 mcd/m²·lux is mounted on the wall, the metal content in the metal hydrate is 50 ppm to 500 ppm, and in the third and fourth steps, the metal hydrate is sprayed 1 to 4 times every 2 hours for 30 to 120 seconds per time.

The fourth step is carried out for 0.5 hours to 12 hours to prevent chlorophyll from being produced, or for 13 hours to 72 hours to produce chlorophyll.

The present disclosure provides a vegetable material grown by the method in which the vegetable material is used as a raw material for cosmetics, health supplements, nutrients, or hangover relievers.

According to the present disclosure, pure metal hydrate without chemicals is prepared and is used as a mineral fertilizer to germinate and grow seeds to improve the growth rate of plant sprouts and provide excellent human affinity and absorption rate and abundant amino acids, mineral nutrients, and antioxidants in grown plant sprouts so that it has the advantage of being able to be used as a vegetable raw material for cosmetics, health foods, hangover relievers, etc.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart showing a hydroponic cultivation method of plant sprouts according to the present disclosure;

FIG. 2 is an SEM photograph of zinc hydrate prepared in Example 1 of the present disclosure;

FIG. 3 is an SEM photograph of iron hydrate prepared in Example 2 of the present disclosure;

FIG. 4 is a photograph of plant sprouts grown by Examples 1 and 2 of the present disclosure and Comparative Example 2;

FIG. 5 is a photograph of the interior of the reflex incubator used in embodiments of the present disclosure; and

FIG. 6 is a view showing an example of zinc carried in plant cells according to the present disclosure.

### DETAILED DESCRIPTION OF EXEMPLARY EMBODIMENTS

Hereinafter, the present disclosure is described in detail.

The method for producing metal hydrate for mineral fertilizer according to the present disclosure has the characteristic of being non-toxic as it excludes chemicals, not inhibiting the growth of plants as it further excludes acid radicals, increasing the content of amino acids as it acts as a catalyst for the production of amino acids and germination energy, and enhancing the content of human-friendly mineral nutrients.

Specifically, the method comprises contacting metal with ultra-high temperature plasma flame of 18,000 to 24,000° C. to grind the metal into extremely fine particles and reacting the extremely fine particles with water to produce the metal hydrate.

First, metal such as pure zinc (Zn) or iron (Fe) is prepared. Then, this metal is installed on a water tank and brought into contact with an ultra-high temperature plasma flame of 18,000 to 24,000° C. Then, the metal is pulverized into extremely fine particles and immediately dropped into water to react with water. The metal pulverized into ultrafine particles attracts and reacts with water molecules to generate hydrated ions, for example, [Fe(H₂O)₂]²⁺ or [Zn(H₂O)₆]²⁺, thereby obtaining a metal hydrate. At this time, the installation of the water tank is to ensure that the thermally pulverized metal immediately reacts with water. It goes without saying that there are no restrictions on its components as long as it can react immediately with water.

At this time, the size of the hydration ion in the metal hydrate is preferably 0.5 nm to 50 nm, which is for effective use as a mineral fertilizer.

Further, the metal content in the metal hydrate is preferably 1,200 ppm to 55,000 ppm. This range is derived considering productivity, etc., and when used as a mineral fertilizer, it is diluted to 50 ppm to 500 ppm.

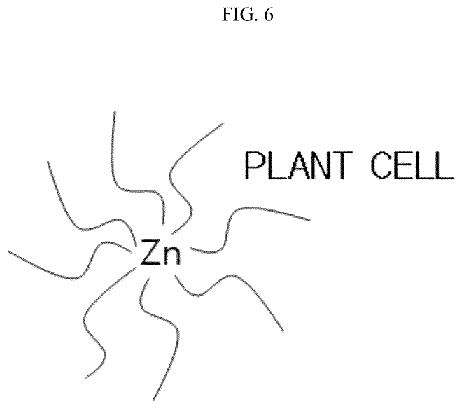

The metal hydrate prepared as described above is non-toxic and does not contain acidic radicals, so it does not inhibit the growth of plants, aids the growth of plants by selectively absorbing only the ionic state or ultra-fine particles together with water during plant growth, and is stored within plant cells so that it can be used as a human-friendly mineral nutrient. Further, as shown in FIG. 6, plant cells serve as carriers of nutrients, making them human-friendly and improving human absorption rate so that it is suitable for use as a mineral raw material.

In addition, the metal hydrate acts as a catalyst for the production of amino acids, which are starch-decomposing enzymes, and germination energy to increase the content of amino acids, thereby being used as a raw material for human-friendly mineral nutrients.

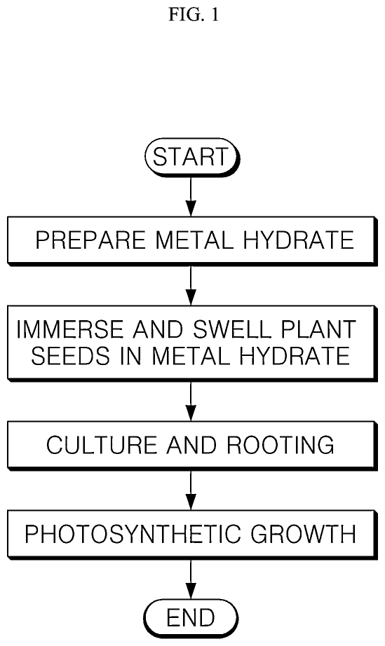

The metal hydrates can be used as mineral fertilizers. The hydroponic cultivation method of plant sprouts using this is described in detail with reference to the attached FIG. 1.

The hydroponic cultivation method of plant sprouts according to the present disclosure comprises the first step of producing the metal hydrate by the method, the second step of adding plant seeds to the metal hydrate and soaking and swelling the plant seeds for 6 to 48 hours at a temperature of 15 to 35° C., the third step of placing the swollen seeds in an incubator and cultivating and rooting the swollen seeds for 8 to 48 hours while spraying the metal hydrate intermittently in shaded conditions, and the fourth step of growing for 0.5 to 72 hours while irradiating light to the rooted seeds and spraying the metal hydrate intermittently, thereby causing cotyledons to open and sprouts to grow photosynthetically.

The first step of producing the metal hydrate

First, the metal hydrate is prepared. The method for preparing the metal hydrate has been sufficiently described above, further description thereof is excluded. However, since the concentration of the metal hydrate used when growing plant sprouts is preferably 10 ppm to 500 ppm, the metal hydrate is diluted to adjust to the above concentration. If the concentration is less than 10 ppm, the effect is minimal, and if the concentration exceeds 50 ppm, problems may arise that limit plant respiration during foliar fertilizer application, causing plant sprouts to fail to grow and die. Hereinafter, the concentration of metal hydrate used when cultivating plant sprouts is 10 ppm to 500 ppm.

The second step of adding plant seeds to the metal hydrate and soaking and swelling the plant seeds for 6 to 48 hours at a temperature of 15 to 35° C.

Next, plant seeds are added to the metal hydrate, immersed, and swollen.

In the present disclosure, the type of plant seed is not limited, and examples include one or more of mung bean, soybean, buckwheat, radish, cabbage, sunflower, barley, wheat, and rice. It goes without saying that a variety of other plant seeds can be used. Further, the amount of metal hydrate used is not limited, as long as the plant seeds can be sufficiently immersed.

When plant seeds are immersed in metal hydrate, the plant seeds absorb water and swell, mitochondria perform cellular respiration, and starch decomposition enzyme is produced. This enzyme is an amino acid. The type and amount of amino acids produced differ depending on the presence or absence of metal hydrate ions. In the present disclosure, various amino acids can be mass-produced through the use of metal hydrates.

At this time, the immersion temperature of 15 to 35° C. is sufficient, and the immersion time of 6 to 48 hours is sufficient.

The third step of placing the swollen seeds in an incubator and cultivating and rooting the swollen seeds for 8 to 48 hours while spraying the metal hydrate intermittently in shaded condition

Next, the swollen plant seeds are placed, cultured, and rooted in an incubator. At this time, it is natural to spread the swollen seeds on a perforated plate that facilitates water drainage.

Further, to promote rooting and produce a large amount of amino acids, it is preferable to intermittently sprinkle the metal hydrate in shaded conditions. At this time, the metal hydrate is sprayed 1 to 4 times every 2 hours for 30 to 120 seconds per time.

This step lasts 8 to 48 hours, which progresses until the roots grow to about 0.1 mm to 5 mm in size.

To explain this process of germination and rooting in detail, plant seeds are full of starch. When germination begins, starch decomposition enzyme is produced to break down the starch, and this germination energy further promotes germination and sprouts. At this time, metal ions such as zinc and iron act as a reaction catalyst that promotes the production reactions of the starch decomposition enzyme and act as a catalyst to produce more starch decomposition enzyme. In particular, when mung bean seeds are germinated, a large amount of aspartic acid, a substance that promotes hangover relief, is produced.

The fourth step of growing for 0.5 to 72 hours while irradiating light to the rooted seeds and spraying the metal hydrate intermittently, thereby causing cotyledons to open and sprouts to grow photosynthetically

The rooted seeds are grown while being irradiated with light, so that the cotyledons open and the sprouts grow through photosynthesis.

At this step, the sprouts are grown for 0.5 to 72 hours while intermittently spraying the metal hydrate, and the metal hydrate is sprayed 1 to 4 times every 2 hours for 30 to 120 seconds per time.

At this time, the light is preferably LED light. This is because flavonoids and anthocyanins are photosynthetically produced as a protective instinct against UV-B in LED light, and after about 12 hours, chlorophyll and anthocyanins are simultaneously produced through photosynthesis. This chlorophyll is a process in which vitamins are formed, and if light continues to be irradiated, anthocyanin decreases, and chlorophyll increases.

Therefore, depending on the purpose of use of the plant material, if chlorophyll is not desired to be produced and only anthocyanin is desired to be formed, sprouts are grown by irradiating light for 0.5 to 12 hours. If anthocyanin and chlorophyll are desired to coexist, sprouts are grown by irradiating light for 13 to 72 hours. For example, when used as a cosmetic raw material, the use of chlorophyll may be limited due to its dark pigment and strong odor, so the fourth step is performed within 12 hours to obtain a non-chlorophyll anthocyanin forming material.

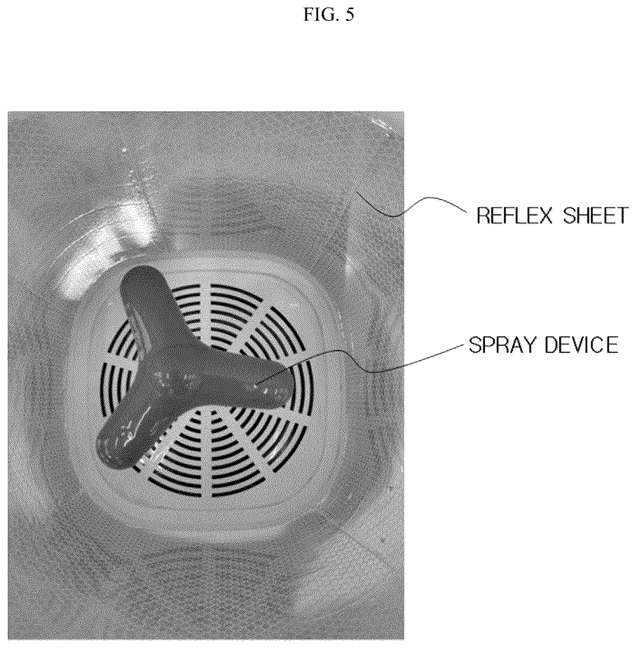

In the present disclosure, as shown in FIG. 5, the incubator is preferably a reflex incubator in which a reflex sheet is mounted on the wall and a spray device is installed inside. This is to facilitate foliar application, amplify the amount of light by refracting and reflecting LED light, increase light efficiency by reducing irradiation blind spots, promote photosynthesis in plants, and save energy. At this time, the luminance of the reflex sheet is preferably 50 to 300 mcd/m²·lux.

Meanwhile, the total process time from the second to fourth steps may be 26 to 168 hours, but most preferably, cultivation is completed within 120 hours (24 hours for the second step, 24 hours for the third step, and 72 hours for the fourth step).

The plant sprouts of the present disclosure grown in the above manner can be used as vegetable raw materials for cosmetics, health supplements, nutrients, or hangover relievers. This is because it is not only rich in anthocyanins and amino acids, which are antioxidant substances, but is also human-friendly and has an excellent absorption rate in the human body as it is a plant-based intestinal carrier mineral in which metal particles are surrounded by plant cells.

Hereinafter, the present disclosure is described in more detail through Examples.

### Example 1

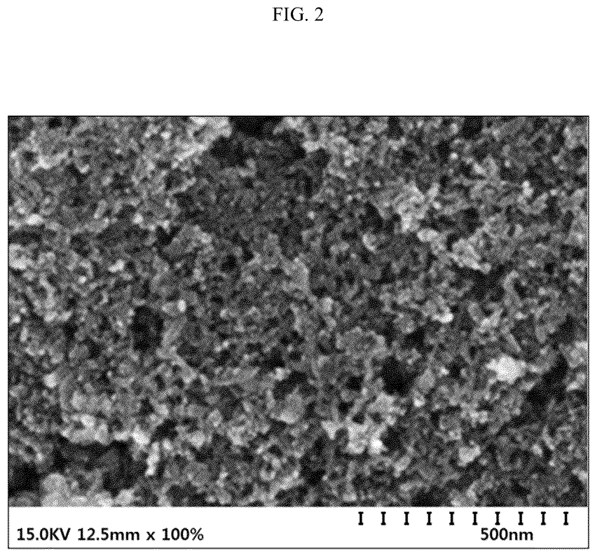

A zinc ingot (700 mm width, 100 mm depth, 50 mm height) was installed on a square tank containing purified water, and a plasma flame at 20,125° C. was brought into contact with the surface to pulverize the zinc ingot and immediately drop it into the water to produce zinc hydrate. At this time, the particle size was 0.5 nm to 50 nm, and the zinc concentration was 3,540 ppm. FIG. 2 is an SEM photograph taken after drying the prepared zinc hydrate.

Next, the concentration of the zinc hydrate was diluted to 97 ppm, and 100 g of mung bean seeds were added to 300 g of the zinc hydrate and immersed and swollen at 25° C. for 24 hours.

Then, the swollen seeds were evenly spread in a reflex incubator in which a reflex sheet with a luminance of 200 mcd/m² lux was mounted on the inner wall, a spray device was mounted, and a perforated plate was mounted on the bottom. Then, in a shaded state with the lid closed, the diluted 97 ppm zinc hydrate was sprayed for foliar fertilizer application 2 times every 2 hours, for 60 seconds each time so that roots were germinated and grown to a size of 2 mm for 24 hours. At this time, 60 g (based on dry weight) of seeds were spread per 400 cm² of the perforated plate.

Next, the lid of the reflex incubator was opened. Then, while irradiating LDE light with an electric capacity of 30 W per 600 cm², the diluted 97 ppm zinc hydrate was sprayed for foliar fertilizer application 2 times every 2 hours for 60 seconds each time. Thus, mung bean sprouts were grown so that the cotyledons opened, and the sprouts grew 3 to 4 mm long.

### Example 2

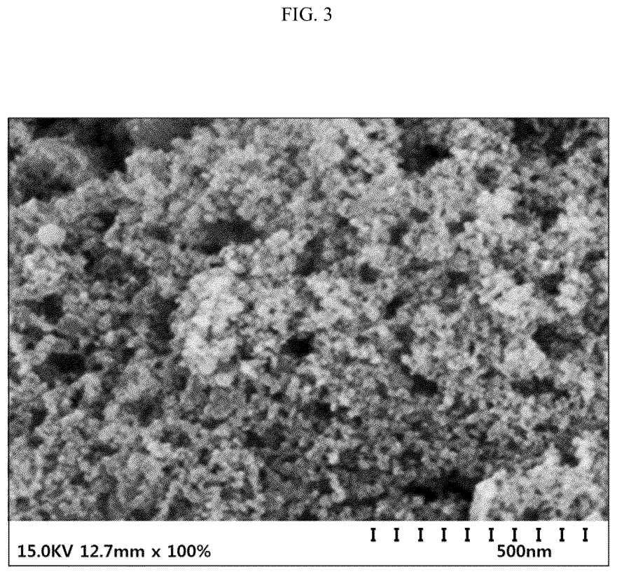

An iron ingot (700 mm width, 100 mm depth, 50 mm height) was installed on a square tank containing purified water, and a plasma flame at 19,326° C. was brought into contact with the surface to pulverize the iron ingot and immediately drop it into the water to produce iron hydrate. At this time, the particle size was 0.5 nm to 50 nm, and the iron concentration was 1,521 ppm. FIG. 3 is an SEM photograph taken after drying the prepared iron hydrate.

Next, the concentration of the iron hydrate was diluted to 124 ppm, and 100 g of mung bean seeds were added to 300 g of the iron hydrate and immersed and swollen at 25° C. for 24 hours.

Then, the swollen seeds were evenly spread in a reflex incubator in which a reflex sheet with a luminance of 200 mcd/m²·lux was mounted on the inner wall, a spray device was mounted, and a perforated plate was mounted on the bottom. Then, in a shaded state with the lid closed, the diluted 134 ppm iron hydrate was sprayed for foliar fertilizer application 2 times every 2 hours, for 60 seconds each time so that roots were germinated and grown to a size of 2 mm for 24 hours. At this time, 60 g (based on dry weight) of seeds were spread per 400 cm² of the perforated plate.

Next, the lid of the reflex incubator was opened. Then, while irradiating LED light with an electric capacity of 30 W per 600 cm², the diluted 134 ppm iron hydrate was sprayed for foliar fertilizer application 2 times every 2 hours for 60 seconds each time. Thus, mung bean sprouts were grown so that the cotyledons opened, and the sprouts grew 3 to 4 mm long.

### Comparative Example 1

100 g of mung bean seeds were input in 300 g of water, immersed and swollen at a temperature of 25° C. for 24 hours. They were placed in an incubator and grown hydroponically for 96 hours while spraying water 2 times every 2 hours in shaded conditions.

### Comparative Example 2

A zinc sulfate water (Zinc sulfate fertilizer registration number: Gyeongbuk Pohang 16-ga-10803) with a solid content of 10 ppm was prepared, and 100 g of mung bean seeds were immersed in 300 g of the zinc sulfate water and immersed and swollen at a temperature of 25° C. for 24 hours.

They were grown in the same manner as in Example 1, but zinc sulfate water was used instead of zinc hydrate.

### Experiment 1

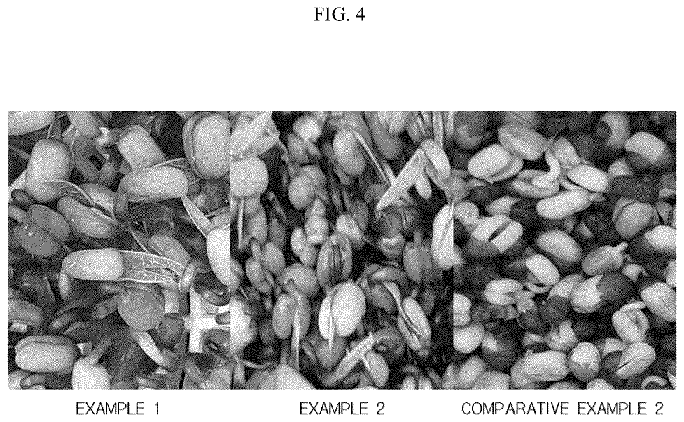

Mung bean sprouts prepared through Examples 1 and 2 and Comparative Example 2 were photographed, and the results are shown in FIG. 4.

It was confirmed that in Examples 1 and 2 according to the present disclosure, the growth state of mung bean sprouts was excellent, but in Comparative Example 2, the growth of mung bean sprouts was limited.

### Experiment 2

Amino acid components of mung bean sprouts prepared through Examples 1 and 2 were analyzed and the contents of anthocyanins, vitamins, Zn, and Fe in Examples 1 and 2 and Comparative Example 1 were analyzed, and the results are shown in Tables 1 and 2 below.

TABLE 1
Component (amino acid) analysis results
according to Experiment 2 (mg/100 g)

| Component (Amino Acid) | Example 1 | Example 2 |
|---|---|---|
| phenylalanine | 1,483.0 | 1,426.6 |
| valine | 1,173.8 | 1,164.7 |
| aspartic acid | 3,883.7 | 4,563.8 |
| glycine | 819.8 | 812.5 |
| serine | 1,323.9 | 1,250.9 |
| threonine | 878.5 | 905.8 |
| histidine | 731.4 | 709.4 |
| tyrosine | 457.9 | 421.0 |
| alanine | 1,075.2 | 1,075.6 |
| glutamic acid | 3,446.1 | 3,374.3 |
| proline | 1,002.2 | 1,032.2 |
| isoleucine | 963.6 | 966.1 |
| leucine | 1,815.8 | 1,779.0 |
| lysine | 1,580.5 | 1,683.9 |
| methionine | 155.8 | 111.1 |
| arginine | 1,557.6 | 1,601.8 |
| Total | 22,348.8 | 22,878.7 |

TABLE 2
Component analysis results according to Experiment 2 (mg/100 g)

| Component | Example 1 | Example 2 | Comparative Example 1 |
|---|---|---|---|
| anthocyanin | 4.9 | 7.04 | 0.0 |
| vitamin | 34.7 | 30.7 | 2.3 |
| Zn | 179.8 | 6.7 | 0.0 |
| Fe | 5.2 | 173.4 | 3.7 |

As can be seen in Tables 1 and 2, it was confirmed that in Examples 1 and 2 of the present disclosure, there were various types of amino acids, and their contents were abundant. It was confirmed that their anthocyanin and vitamin contents were significantly higher than those in Comparative Example 1. Further, it was confirmed that Example 1 contained a large amount of zinc and Example 2 contained a large amount of iron, confirming that it could be used as a mineral raw material. In particular, in Examples 1 and 2, it was confirmed that a large amount of aspartic acid was produced among amino acids.

As such, the present disclosure is not limited to the described examples, and it is obvious to those skilled in the art that various modifications and changes can be made without departing from the spirit and scope of the present disclosure. Accordingly, such modifications or variations should be considered to fall within the scope of the claims of the present disclosure.

What is claimed is:

1. A method of preparing a metal hydrate for mineral fertilizer, the method comprising:
contacting metal with ultra-high temperature plasma flame of 18,000 to 24,000° C. to grind the metal into extremely fine particles; and
reacting the extremely fine particles with water to produce the metal hydrate.

2. The method of claim 1, wherein a size of a hydration ion in the metal hydrate is 0.5 nm to 50 nm, and
wherein a metal content in the metal hydrate is 1,200 ppm to 55,000 ppm.

3. The method of claim 1, wherein the metal is zinc or iron, and
wherein a hydration ion in the metal hydrate is [Fe(H₂O)₂]²⁺ or [Zn(H₂O)₆]²⁺.

4. A hydroponic cultivation method of plant sprouts, the method comprising:
a first step of producing the metal hydrate by the method of claim 1;
a second step of adding plant seeds to the metal hydrate and soaking and swelling the plant seeds for 6 to 48 hours at a temperature of 15 to 35° C.;
a third step of placing the swollen seeds in an incubator and cultivating and rooting the swollen seeds for 8 to 48 hours while spraying the metal hydrate intermittently in shaded conditions; and
a fourth step of growing for 0.5 to 72 hours while irradiating light to the rooted seeds and spraying the metal hydrate intermittently, thereby causing cotyledons to open and sprouts to grow photosynthetically.

5. The method of claim 4, wherein the incubator is a reflex incubator in which a Reflex sheet with a luminance of 50 to 300 mcd/m²·lux is mounted on the wall,
wherein the metal content in the metal hydrate is 50 ppm to 500 ppm, and
wherein in the third and fourth steps, the metal hydrate is sprayed 1 to 4 times every 2 hours for 30 to 120 seconds per time.

6. The method of claim 4, wherein the fourth step is carried out for 0.5 hours to 12 hours to prevent chlorophyll from being produced, or for 13 hours to 72 hours to produce chlorophyll.

7. A vegetable material grown by the method of claim 4, wherein the vegetable material is used as a raw material for cosmetics, health supplements, nutrients, or hangover relievers.
